(19) United States
(12) Patent Application Publication
(10) Pub. No.: US 2024/0214090 A1
(43) Pub. Date: Jun. 27, 2024

(54) WIRELESS COMMUNICATION APPARATUS AND OPERATING METHOD THEREOF

(71) Applicant: SAMSUNG ELECTRONICS CO., LTD., Suwon-si (KR)

(72) Inventors: Minki AHN, Suwon-si (KR); Jinyong LEE, Suwon-si (KR); Jung Woon LEE, Suwon-si (KR)

(73) Assignee: SAMSUNG ELECTRONICS CO., LTD., Suwon-si (KR)

(21) Appl. No.: 18/394,751

(22) Filed: Dec. 22, 2023

(30) Foreign Application Priority Data
Dec. 27, 2022 (KR) 10-2022-0186022

(51) Int. Cl. H04B 17/336; H04B 1/12

(52) U.S. Cl. CPC H04B 17/336; H04B 1/12

(57) ABSTRACT

The present disclosure provides wireless communication apparatuses for data communication with other wireless communication apparatuses in a wireless communication system. In some embodiments, a first wireless communication apparatus includes a transceiver configured to receive a data signal from a second wireless communication apparatus through a channel, and a processing circuit configured to measure noise, a signal to noise ratio (SNR), and error vector magnitude (EVM) of the data signal, compare the SNR with the EVM, and selectively perform, based on a result of the comparison of the SNR with the EVM, a correction operation on the noise.

### CROSS-REFERENCE TO RELATED APPLICATIONS

This application is based on and claims priority under 35 U.S.C. § 119 to Korean Patent Application No. 10-2022-0186022, filed on Dec. 27, 2022, in the Korean Intellectual Property Office, the disclosure of which is incorporated by reference herein in its entirety.

### BACKGROUND

The present disclosure relates to a wireless communication apparatus, and more particularly, to a wireless communication apparatus which performs data communication with other wireless communication apparatuses in a wireless communication system, and an operating method of the same.

Wireless local area network (WLAN) is a technology for connecting two or more devices to each other by using a wireless signal transmission method. For example, a WLAN may be based on the Institute of Electrical and Electronics Engineers (IEEE) 802.11x standard. The IEEE 802.11 standard has evolved into several versions that may include, but not be limited to, 802.11a, 802.11b, 802.11g, 802.11n, 802.11ac, 802.11ax, and the like. A WLAN conforming to at least one version of the IEEE 802.11 standard may support a high transmission rate based on orthogonal frequency-division multiplexing (OFDM) technology.

However, notwithstanding a high transmission rate that may be supported in a WLAN system, the communication performance of the WLAN system may be degraded due to in-phase & quadrature (IQ) imbalance of a data signal in actual wireless communication and/or due to signal saturation on the transmission side.

### SUMMARY

Example embodiments provide a wireless communication apparatus that potentially corrects noise for a data signal in consideration of a difference between a signal to noise ratio (SNR) and error vector magnitude (EVM) of the data signal to possibly prevent degradation in the communication performance due to the in-phase & quadrature (IQ) imbalance of the data signal and signal saturation on the transmission side, and an operating method of the wireless communication apparatus.

According to an aspect of an example embodiment, a first wireless communication apparatus includes a transceiver configured to receive a data signal from a second wireless communication apparatus through a channel, and a processing circuit configured to measure noise, a signal to noise ratio (SNR), and error vector magnitude (EVM) of the data signal, compare the SNR with the EVM, and selectively perform, based on a result of the comparison of the SNR with the EVM, a correction operation on the noise.

According to an aspect of an example embodiment, a first wireless communication apparatus includes a transceiver configured to receive a data signal from a second wireless communication apparatus through a channel, and a processing circuit configured to measure noise, an SNR, and EVM of the data signal, perform a correction operation on the noise when a difference between the SNR and the EVM exceeds a threshold value, and process the data signal, based on a result of performing the correction operation.

According to an aspect of an example embodiment, a first wireless communication apparatus includes a transceiver comprising a first radio frequency (RF) chain that is inactivated in a power saving mode and a second RF chain that is activated in the power saving mode, and a processing circuit configured to correct first noise of a first data signal transmitted through the first RF chain in an initial activation period when switching from the power saving mode to a normal mode, based on a first EVM of the first data signal and a second EVM of a second data signal transmitted through the second RF chain.

Additional aspects are set forth in part in the description which follows and, in part, may be apparent from the description, and/or may be learned by practice of the presented embodiments

### BRIEF DESCRIPTION OF THE DRAWINGS

The above and other aspects, features, and advantages of certain example embodiments of the present disclosure may be more apparent from the following description taken in conjunction with the accompanying drawings, in which:

FIG. 1 is a block diagram illustrating a wireless communication system, according to an embodiment;

FIG. 2 is a block diagram illustrating a wireless communication system, according to an embodiment;

FIG. 3A is a diagram illustrating a frame format of a data signal in the wireless communication system of FIG. 2, for describing a method of measuring noise and a signal to noise ratio (SNR) of a data signal, according to an embodiment;

FIG. 3B is a diagram for describing a method of measuring error vector magnitude (EVM) of a data signal, according to an embodiment;

FIG. 4 is a flowchart of an operating method of a first wireless communication apparatus, according to an embodiment;

FIG. 5 is a flowchart of an operating method of a first wireless communication apparatus, according to an embodiment;

FIG. 6 is a flowchart of a detailed embodiment of operation S120 of FIG. 5, according to an embodiment;

FIGS. 7A and 7B are flowcharts of a detailed embodiment of operation S120 of FIG. 5, according to an embodiment;

FIG. 8 is a block diagram illustrating a first wireless communication apparatus, according to an embodiment;

FIG. 9 is a flowchart of an operation of a first wireless communication apparatus, according to an embodiment;

FIG. 10 is a block diagram illustrating a measurement circuit, according to an embodiment;

FIG. 11 is a flowchart of an operation of a first wireless communication apparatus, according to an embodiment; and

FIG. 12 is a conceptual diagram illustrating an Internet of Things (IoT) network system in which embodiments of the present disclosure are applied.

### DETAILED DESCRIPTION

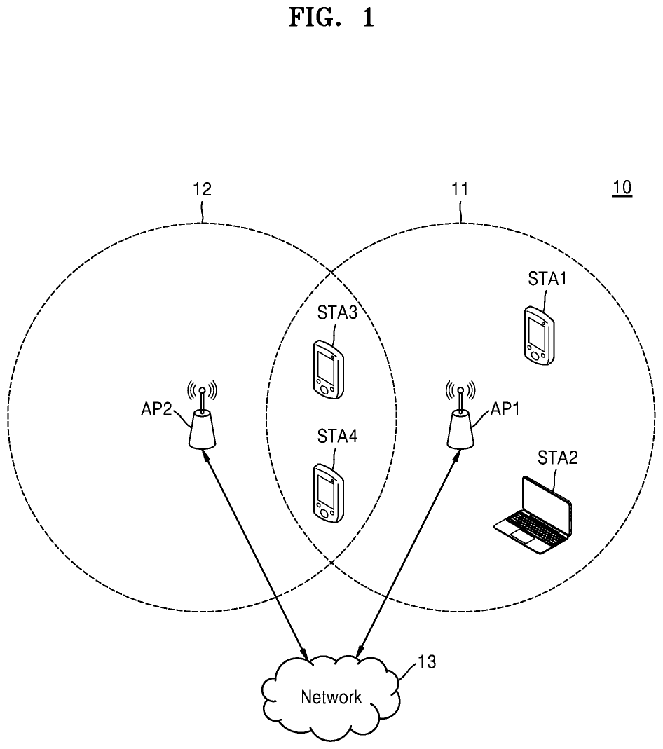

FIG. 1 is a block diagram illustrating a wireless communication system 10, according to an embodiment.

Referring to FIG. 1, a wireless local area network (WLAN) system is illustrated as an example of the wireless communication system 10.

Aspects presented herein may be described based on an orthogonal frequency-division multiplexing (OFDM)-based and/or an orthogonal frequency-division multiple access (OFDMA)-based wireless communication system, such as, but not limited to, a wireless communication system based on the Institute of Electrical and Electronics Engineers (IEEE) 802.11 standard. However, the present disclosure is not limited in this regard. For example, the present disclosure may also be applied to similar technical backgrounds and/or other communication systems having a channel form (e.g., a cellular communication system such as, but not limited to, long term evolution (LTE), LTE-advanced (LTE-A), new radio (NR), wireless broadband (WiBro), global system for mobile communication (GSM), and/or a short-range communication system such as, but not limited to, Bluetooth™, and near field communication (NFC)), without deviating from the scope of the present disclosure.

Alternatively or additionally, various functions described below may be implemented and/or supported by one or more computer programs, each of which may be composed of computer readable program code and may be implemented in a computer readable medium. As used herein, the terms “application” and “program” may refer to one or more computer programs, software components, sets of instructions, procedures, functions, objects, classes, instances, related data, or portions thereof suitable for implementation in suitable computer readable program code. As used herein, the term “computer readable program code” may refer to all types of computer code, including, but not limited to, source code, object code, and executable code. As used herein, the term “computer readable medium” may refer to any type of media accessible by a computer, such as, but not limited to, read only memory (ROM), random access memory (RAM), hard disk drive (HDD), compact disc (CD), digital video disc (DVD), or any other type of memory. A “non-transitory” computer readable medium may exclude wired, wireless, optical, or other communication links through which transitory electrical and/or other signals may be transmitted. Non-transitory computer readable media may be and/or may include media on which data may be permanently stored, and/or media on which data may be stored and subsequently overwritten, such as, but not limited to, rewritable optical discs and removable memory devices.

Referring to FIG. 1, the wireless communication system 10 may include a first access point AP1, a second access point AP2, and four (4) stations (e.g., first station STA1, second station STA2, third station STA3, and fourth station STA4). The first and second access points AP1 and AP2 may access a network 13 that may be and/or may include the Internet, an internet protocol (IP) network, and/or any other network. The first access point AP1 may provide access to the network 13 to the first to fourth stations STA1 to STA4 that may be located within a first coverage area 11. The second access point AP2 may also provide access to the network 13 to the third and fourth stations STA3 and STA4 that may be located within a second coverage area 12. In some embodiments, the first and second access points AP1 and AP2 may communicate with at least one of the first to fourth stations STA1 to STA4 based on Wireless Fidelity (WiFi) and/or any other WLAN access technology.

An access point may be referred to as a router, a gateway, and the like, and a station may be referred to as a mobile station, a subscriber station, a terminal, a mobile terminal, a wireless terminal, or a user equipment, and the like. In an embodiment, the station may be and/or may include a portable device such as, but not limited to, a mobile phone, a laptop computer, and a wearable device, or may be and/or may include a stationary device such as, but not limited to, a desktop computer and a smart television (TV). Other examples of access points and stations are described with reference to FIG. 14.

In an embodiment, the first station STA1 may perform data communication with the first access point AP1. As used herein, the first station STA1 may be referred to as a first wireless communication apparatus, and/or the first access point AP1 may be referred to as a second wireless communication apparatus.

For example, the first station STA1 may receive a data signal from the first access point AP1 through a channel. In such an example, the first station STA1 may measure noise, a signal to noise ratio (SNR), and error vector magnitude (EVM) of the received data signal. As used herein, noise may refer to a noise power.

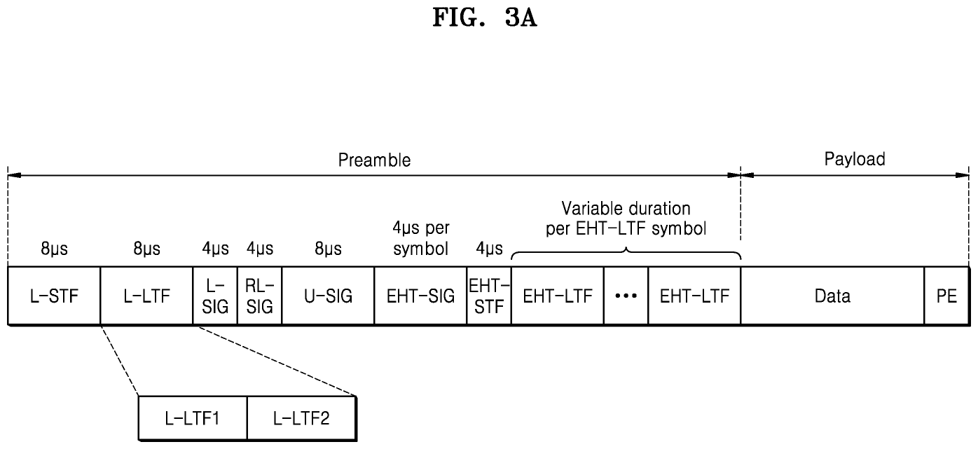

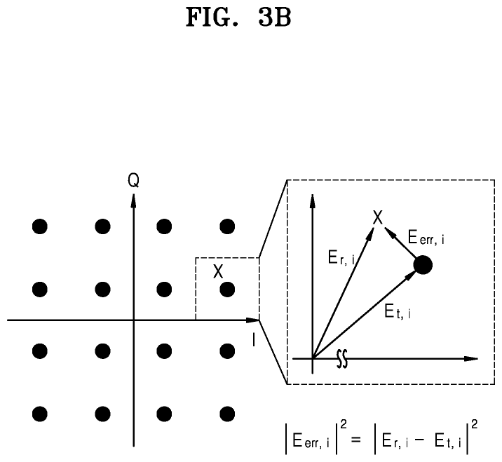

In an embodiment, a data signal received by the first station STA1 may be impaired due to an in-phase & quadrature (IQ) imbalance that may be caused, for example, due to hardware limitations of the first station STA1, or due to signal saturation that may be caused, for example, due to the hardware limitations of the first access point AP1. For example, a data signal may be impaired due to the IQ imbalance of the data signal caused by structural limitations of an analog converter that may down-convert the frequency of the data signal (e.g., a radio frequency (RF) signal of the first station STA1). For another example, the data signal may be saturated due to a problem in a peak-to-average power ratio (PAPR) of a power amplifier of the transmitting device and transmitted to the first station STA1. In an embodiment, noise and SNR of the data signal that may be measured by the first station STA1 may not be affected by the impairment of the data signal, whereas a measured EVM of the data signal may be affected by the impairment of the data signal. The discrepancy in the measurements of the data signal may be a result of different measurement methods used for measuring noise, SNR, and EVM of the data signal. An example of a noise and SNR measurement method is described with reference to FIG. 3A, and an example of an EVM measurement method is described with reference to FIG. 3B.

For example, when the first station STA1 measures noise of a saturated data signal, the measured noise may be less than the actual noise of the data signal. Since a factor related to log likelihood ratio (LLR) quantization in channel decoding may be determined based on the size of the measured noise, an inaccurate noise measurement may degrade channel decoding performance of the first station STA1. For another example, when the first station STA1 measures an SNR of the saturated data signal, the measured SNR may be greater than the actual SNR of the data signal. The measured SNR may be associated with noise that is measured to be less than the actual noise.

In an embodiment, the first station STA1 may compare the measured SNR with the measured EVM of the received data signal, and selectively perform a correction operation on the measured noise based on a result of the comparison. For example, the first station STA1 may detect impairment of the received data signal, when a difference between the measured SNR and the measured EVM exceeds a threshold value. That is, as there is a difference between the noise measured for the impaired data signal and the actual noise, the first station STA1 may perform a correction operation to narrow the difference between the measured noise and the actual noise.

In an optional or additional embodiment, when the difference between the measured SNR and the measured EVM exceeds a threshold value, the first station STA1 may perform a correction operation on the measured noise based on the difference between the measured SNR and the measured EVM.

The operation of comparing the measured SNR with the measured EVM may include directly comparing the measured SNR with the measured EVM, multiplying the measured SNR by a first weight, multiplying the measured EVM by a second weight, and comparing multiplication results.

The correction operation of the measured noise may include directly correcting the measured noise and/or indirectly correcting at least one factor related to the measured noise.

The first station STA1, according to an embodiment, may compare an SNR measured from a data signal with measured EVM and detect whether the data signal is impaired, based on a result of the comparison, and selectively perform a correction operation on the measured noise to thereby improve the accuracy of the measured noise. As a result, the first station STA1 may prevent degradation of reception performance due to impairment of the data signal.

It will be readily understood that the selective correction operation on the measured noise according to the present disclosure may also be performed by other wireless communication apparatuses (e.g., STA2 to STA4, AP1, and AP2) in the wireless communication system 10 in addition to and/or instead of the first station STA1.

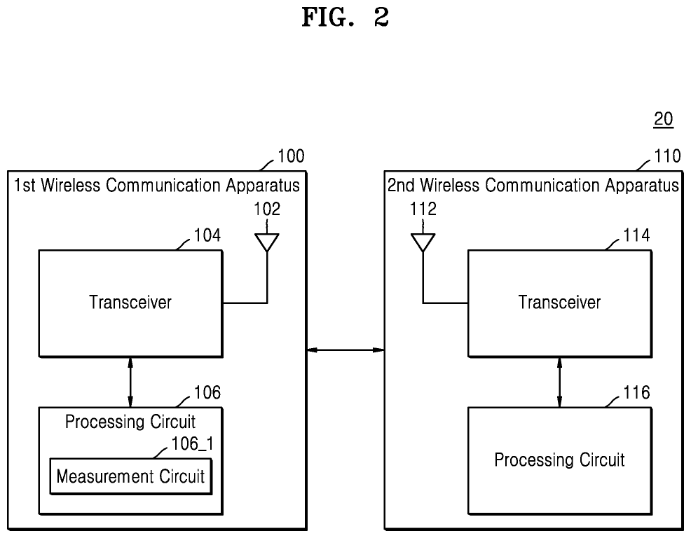

FIG. 2 is a block diagram illustrating a wireless communication system 20 according to an embodiment. FIG. 3A illustrates a frame format of a data signal in the wireless communication system 20 of FIG. 2, for describing a method of measuring noise and an SNR of a data signal. FIG. 3B is a diagram for describing a method of measuring EVM of a data signal.

As shown in the block diagram of FIG. 2, a first wireless communication apparatus 100 and a second wireless communication apparatus 110 may perform mutual data communication in the wireless communication system 20. Each of the first wireless communication apparatus 100 and the second wireless communication apparatus 110 of FIG. 2 may be an apparatus that communicates in the wireless communication system 20 and may be referred to as an apparatus for wireless communication. In some embodiments, each of the first wireless communication apparatus 100 and the second wireless communication apparatus 110 may be an access point (AP) and/or a station of a WLAN system.

Referring to FIG. 2, the first wireless communication apparatus 100 may include an antenna 102, a transceiver 104, and a processing circuit 106. In some embodiments, the antenna 102, the transceiver 104, and the processing circuit 106 may be included in one package and/or may be included in different packages. The second wireless communication apparatus 110 may include an antenna 112, a transceiver 114 and a processing circuit 116. Hereinafter, repeated descriptions of the first wireless communication apparatus 100 and the second wireless communication apparatus 110 may be omitted. Alternatively or additionally, the description may be based on an embodiment in which the first wireless communication apparatus 100 receives a data signal from the second wireless communication apparatus 110. That is, the first wireless communication apparatus 100 may correspond to a receiving device, and the second wireless communication apparatus 110 may correspond to a transmitting device.

In an embodiment, the antenna 102 may receive a data signal from the second wireless communication apparatus 110 and provide the data signal to the transceiver 104. In some embodiments, the antenna 102 may be and/or may include a phased array for beamforming. The transceiver 104 may process the data signal received via the antenna 102 and provide the data signal to the processing circuit 106. In some embodiments, the transceiver 104 may include analog circuits such as, but not limited to, a low noise amplifier, a mixer, a filter, a power amplifier, and the like.

The processing circuit 106 may include a measurement circuit 106_1. In an embodiment, the measurement circuit 106_1 may measure noise, an SNR, and EVM of a data signal provided by the transceiver 104, compare the measured SNR with the measured EVM, and selectively perform a correction operation on the measured noise, based on a result of the comparison. In an embodiment, the processing circuit 106 may include the measurement circuit 106_1, however the present disclosure is not limited thereto, and the operation of the measurement circuit 106_1 may be understood as an operation of the processing circuit 106.

Referring to FIG. 3A, a frame format of a data signal may include a preamble including training fields and signaling fields and a payload including a data field. The frame format may include, in the preamble, a legacy-short training field (L-STF), a legacy-long training field (L-LTF), a legacy-signal (L-SIG) field, a repeated legacy-signal (RL-SIG) field, including a universal signal (U-SIG) field, an extremely high throughput-signal (EHT-SIG) field, an extremely high throughput-short training field (EHT-STF), and an extremely high throughput-long training field (EHT-LTF). In addition, the frame format may include a data field and a packet extension (PE) field in a payload. In some embodiments, EHT-SIG may be replaced with HT-SIG, V-SIG or HE-SIG. Alternatively or additionally, EHT-LTF may also be replaced with HT-SIG, V-SIG or HE-SIG.

The L-LTF may include a first L-LTF LTF1 and a second L-LTF LTF2 that may be contiguous to each other in the frame of the data signal. Alternatively or additionally, the first L-LTF LTF1 and the second L-LTF LTF2 may contain a same pattern of data. In an embodiment, the L-LTF may further include at least one other field (e.g., a third L-LTF). The measurement circuit 106_1 may measure noise and an SNR of a data signal in a time domain and/or frequency domain by using the first L-LTF L-LTF1 and the second L-LTF L-LTF2.

For example, in the frequency domain, the first L-LTF L-LTF1 and the second L-LTF L-LTF2 may be defined by Equation 1 below. In the following equations, ‘L-LTF1’ may be expressed as ‘L_LTFP’, and ‘L-LTF2’ may be expressed as ‘L_LTF2’.

$$L\_LTF1 ( k ) = h ( k ) s ( k ) + {n}_{1} \\ L\_LTF2 ( k ) = h ( k ) s ( k ) + {n}_{2} \qquad [ Equation 1 ]$$

Referring to Equation 1, h(k) may represent a channel response of a k-th sub-carrier, s(k) may represent an L-LTF sequence of the k-th sub-carrier, and nₗ (l=1, 2) may represent additive white Gaussian noise (AWGN) of the k-th sub-carrier.

An average P_{sig,t} of sums of received powers of the first L-LTF L-LTF1 and the second L-LTF L-LTF2 and an average P_{nois,t} of differences between the received powers of the first L-LTF L-LTF1 and the second L-LTF L-LTF2 may be defined as Equation 2 below.

$${P}_{sig , t} = \frac{{\sum }_{i ∈ ω}^{N} {\vert L\_LTF1 ( i ) + L\_LTF2 ( i ) \vert}^{2}}{N} \\ {P}_{nois , t} = \frac{{\sum }_{i ∈ ω}^{N} {\vert L\_LTF1 ( i ) - L\_LTF2 ( i ) \vert}^{2}}{N} \qquad [ Equation 2 ]$$

Referring to Equation 2, w may represent a sub-carrier set including at least one index of sub-carriers of a data signal, N may represent a number of indexes of sub-carriers, and i may represent an index of an i-th sub-carrier. In an embodiment, the measurement circuit 106_1 may measure noise of the data signal such that the noise may coincide with the average P_{nois,t} of the differences of the reception powers.

By using Equation 2, an SNR of the data signal may be defined as Equation 3 below.

$${SNR}_{dB} = 10 \cdot {log}_{10} ( \frac{{P}_{sig , t}}{2 \times {P}_{nois , t}} ) \qquad [ Equation 3 ]$$

In an embodiment, the measurement circuit 106_1 may measure the SNR of the data signal based on a difference between the average P_{sig,t} of sums of Eq. 2 and the average P_{nois,t} of differences of Equation 2.

As described above with reference to FIG. 1, the noise and the SNR may be measured through the sum and difference of the received powers of the first L-LTF L-LTF1 and the second L-LTF L-LTF2 of the data signal, and thus, the above measured values may not be affected by the impairment of the data signal. That is, the above measured values may be substantially similar and/or may be the same as the actual measured values.

In an embodiment, the noise measured by the measurement circuit 106_1 may be used to adjust LLR quantization bits. LLR quantization bits may be associated with a Q factor, and the Q factor may indicate the number of fractional bits of the LLR for a floating point operation. That is, the Q factor may be used to adjust the quantization unit for the LLR. A correction operation on noise, that is described below, may be implemented by adjusting the Q factor. Also, noise measured by the measurement circuit 106_1 may be used for a whitening operation for symbol detection of the data signal.

The SNR measured by the measurement circuit 106_1 may be used in design or configuration for optimal reception. For example, the measured SNR may be used to calculate an optimal weight for maximum ratio combining (MRC) and/or to determine an optimal smoothing filter coefficient for channel estimation.

Referring to FIG. 3B, the measurement circuit 106_1 may measure an EVM value representing a distance at which symbols of the received data signal may be separated from positions of ideal constellations.

For example, the measurement circuit 106_1 may measure EVM E_{err,i} by using a first vector E_{r,i} which may face a symbol of an i-th sub-carrier of a received data signal, and using a second vector E_{t,i} which may face an ideal constellation corresponding to the symbol of the i-th sub-carrier. In an embodiment, EVM E_{err,i} may be defined by Equation 4 below.

$${\vert {E}_{err , i} \vert}^{2} = {\vert {E}_{r , i} - {E}_{t , i} \vert}^{2} \qquad [ Equation 4 ]$$

The measurement circuit 106_1 may measure the EVM E_{err,i} of the symbol of the i-th sub-carrier by using SIG portions of the preamble of FIG. 3A (e.g., L-SIG, RL-SIG, EHT-LTF).

As described above, since an EVM measurement may be affected by impairment of a data signal unlike noise and SNR measurements, EVM may be used together with an SNR to detect impairment of a data signal. That is, the measurement circuit 106_1 may detect the impairment of the data signal by comparing the EVM that may be affected by the impairment of the data signal with the SNR that may not be affected by the impairment of the data signal.

Referring back to FIG. 2, when the difference between the measured SNR and the measured EVM exceeds a threshold value, the measurement circuit 106_1 may perform a correction operation on the measured noise based on the difference between the measured SNR and the measured EVM. In the embodiments described below, it may be assumed that the difference between the measured SNR and the measured EVM exceeds the threshold value, and thus, the measurement circuit 106_1 may perform a correction operation on the measured noise.

In an embodiment, the measurement circuit 106_1 may perform a correction operation on the measured noise by multiplying the difference between the measured SNR and the measured EVM by a first scaling factor, and adjusting the Q factor determined by the measured noise based on a result of the multiplication. As described above, the Q factor may represent the number of fractional bits of LLR. In an embodiment, whenever the number of fractional bits is adjusted by one, a noise correction step of 3 dB may be obtained. For example, the above embodiment may be defined as Equation 5 below.

$${SNR}_{diff} = SNR - {EVM}_{SIG} [ dB ] \\ if {SNR}_{diff} > th , {Q}_{factor} -= α \times {SNR}_{diff} \qquad [ Equation 5 ]$$

When a difference SNR_{diff} between a measured SNR SNR and a measured EVM EVM_{SIG} exceeds a threshold value th, the measurement circuit 106_1 may perform a correction operation on noise by multiplying the difference SNR_{diff} by a first scaling factor (α), and perform a correction operation on noise by subtracting, from the Q factor Q_{factor}, the result of the multiplication of the difference SNR_{diff} by the first scaling factor (a). In some embodiments, the threshold value th may be a preset system parameter value in a wireless communication system. Alternatively or additionally, the first scaling factor α may be preset in the first wireless communication apparatus 100. In some embodiments, the first scaling factor α may be varied according to at least one of a channel stage between the first wireless communication apparatus 100 and the second wireless communication apparatus 110, the performance of the first wireless communication apparatus 100, or the performance of the second wireless communication apparatus 110.

In an embodiment, the measurement circuit 106_1 may generate a second scaling factor based on a difference between the measured SNR and the measured EVM, and may perform a correction operation on the measured noise by multiplying the measured noise by the second scaling factor. That is, the measurement circuit 106_1 may generate the second scaling factor having a larger value as the difference between the measured SNR and the measured EVM increases, thereby correcting the measured noise to a relatively great degree. In some embodiments, the measurement circuit 106_1 may generate the second scaling factor having a smaller value as the difference between the measured SNR and the measured EVM decreases, thereby correcting the measured noise to a relatively small degree.

In an embodiment, the measurement circuit 106_1 may generate the second scaling factor with reference to a table including a list of values of the second scaling factor that are mapped according to the difference between the measured SNR and the measured EVM.

In an embodiment, the measurement circuit 106_1 may generate a third scaling factor based on the difference between the measured SNR and the measured EVM, and may perform a correction operation on the measured noise by multiplying a reciprocal of the standard deviation of the measured noise by the third scaling factor. For example, the measurement circuit 106_1 may calculate a scaled reciprocal of the standard deviation of the measured noise using Equation 6 below.

$$if {SNR}_{diff} > th , NIV 2 = ρ \times NIV 1 \qquad [ Equation 6 ]$$

When a difference SNR_{diff} between the measured SNR SNR and the measured EVM EVM_{SIG} exceeds a threshold value th, the measurement circuit 106_1 may generate a third scaling factor ρ, and generate a second NIV NIV2 by multiplying the third scaling factor ρ by the first NIV NIV1 to thereby perform a correction operation on the measured noise. As used herein, NIV may refer to a reciprocal of the standard deviation of the measured noise. In some embodiments, NIV may be used in a whitening operation for symbol detection of a data signal.

In an embodiment, the measurement circuit 106_1 may perform a correction operation on the measured noise by generating replacement noise based on the measured EVM and replacing the measured noise with the measured noise. That is, considering that EVM may be affected by impairment of a data signal, the measurement circuit 106_1 may generate replacement noise based on the measured EVM, to replace the measured noise. Replacement noise may be used in whitening operations for data symbol detection. In some embodiments, noise may be realized by a reciprocal of a standard deviation of the noise. For example, the measurement circuit 106_1 may calculate the noise using Equation 7 below.

$${σ}_{n}^{2} = {EVM}_{SIG} \\ NIV\_R = \frac{1}{{σ}_{n}} from {σ}_{n}^{2} \qquad [ Equation 7 ]$$

The measurement circuit 106_1 may define the measured EVM EVM_{SIG} as a square of the standard deviation an and generate a replacement NIV NIV_R from the measured EVM EVM_{SIG}. The measurement circuit 106_1 may replace the measured NIV with the replacement NIV NIV_R.

Referring to FIG. 2, the processing circuit 106 may extract information transmitted by the second wireless communication apparatus 110 by processing the data signal received from the transceiver 104. For example, the processing circuit 106 may extract information by demodulating and/or decoding the data signal by using at least one of the measured SNR, the measured EVM, and the measured and/or corrected noise.

In an embodiment, the second wireless communication apparatus 110 may receive a data signal from the first wireless communication apparatus 100. In such an embodiment, the above-described embodiments relating to the first wireless communication apparatus 100 may also be applied to the second wireless communication apparatus 110.

The measurement circuit 106_1, according to an embodiment, may detect impairment of a data signal received from the second wireless communication apparatus 110 and perform a correction operation on noise measured from the data signal, thereby minimizing the impairment and/or maximizing the reception performance.

In an embodiment, the measurement circuit 106_1 may perform a correction operation on the measured noise based on the difference between the measured SNR and the measured EVM, thereby correcting the noise measurement to be similar to the actual noise.

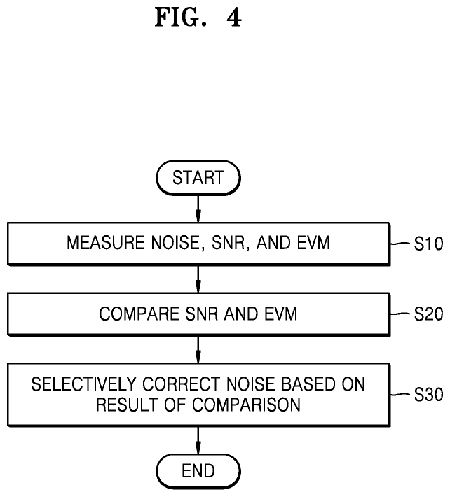

FIG. 4 is a flowchart of an operating method of a first wireless communication apparatus, according to an embodiment.

Referring to FIG. 4, in operation S10, the first wireless communication apparatus may measure noise, an SNR, and EVM of a data signal received through a channel from a second wireless communication apparatus.

In operation S20, the first wireless communication apparatus may compare the measured SNR with the measured EVM. In an embodiment, the first wireless communication apparatus may detect impairment of the received data signal based on the difference between the measured SNR and the measured EVM.

In operation S30, the first wireless communication apparatus may selectively correct noise measured based on a result of the comparison of operation S20. In an embodiment, the first wireless communication apparatus may correct the measured noise when impairment of the received data signal is detected based on the result of the comparison of performed in operation S20.

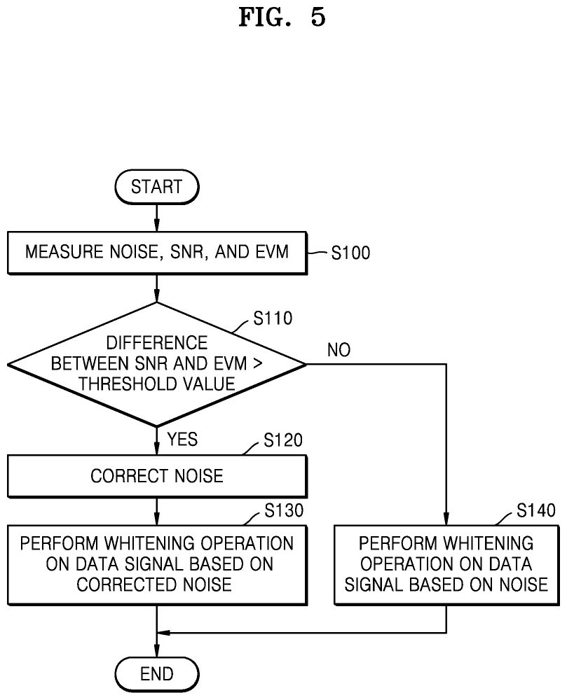

FIG. 5 is a flowchart of an operating method of a first wireless communication apparatus, according to an embodiment.

Referring to FIG. 5, in operation S100, the first wireless communication apparatus may measure noise, an SNR, and EVM of a data signal received through a channel from a second wireless communication apparatus.

In operation S110, the first wireless communication apparatus may determine whether a difference between the SNR measured in operation S100 and the measured EVM exceeds a threshold value.

When the difference between the SNR measured and the measured EVM exceeds the threshold value (e.g., YES in operation S110), the first wireless communication apparatus may, in operation S120, correct the noise measured in operation S100.

In operation S130, the first wireless communication apparatus may perform a whitening operation on the data signal based on the corrected noise.

When the difference between the SNR measured and the measured EVM does not exceed the threshold value (e.g., NO in operation S110), the first wireless communication apparatus may, in operation S140, perform a whitening operation on the data signal based on the noise measured in operation S100.

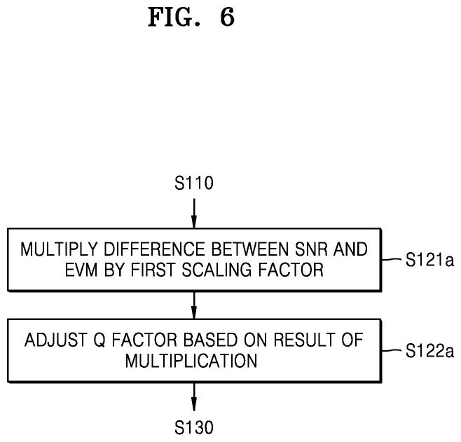

FIG. 6 is a flowchart of a detailed embodiment of operation S120 of FIG. 5. In FIG. 6, an embodiment in which the noise measured is indirectly corrected in operation S120 of FIG. 5 is described.

Referring to FIG. 6, subsequent to operation S110, in operation S121a, the first wireless communication apparatus may multiply a difference between the measured SNR and the measured EVM in operation S100 by a first scaling factor.

In operation S122a, the first wireless communication apparatus may indirectly correct the measured noise by adjusting the Q factor based on a result of the multiplication of operation S121a. As described above, the Q factor may be used to adjust a quantization unit for the LLR.

However, the present disclosure is not limited in this regard. For example, the first wireless communication apparatus may indirectly correct the measured noise by applying a first scaling factor to at least one of various factors determined by the measured noise.

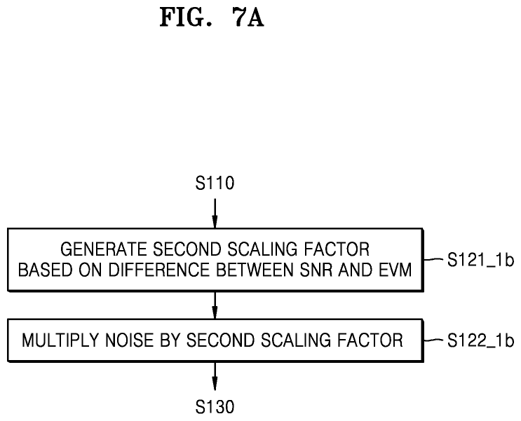

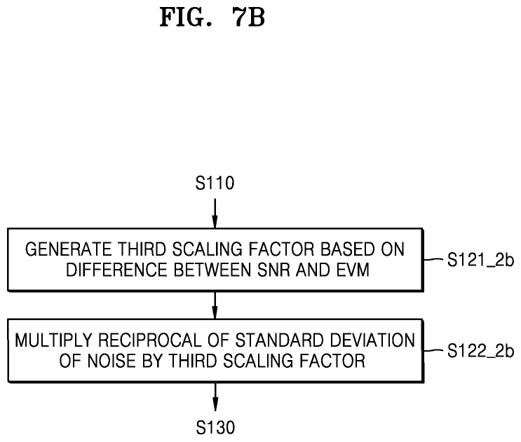

FIGS. 7A and 7B are flowcharts of a detailed embodiment of operation S120 of FIG. 5.

Referring to FIG. 7A, subsequent to operation S110, in operation S121_1b, the first wireless communication apparatus may generate a second scaling factor based on the difference between the measured SNR and the measured EVM in operation S100.

In operation S122_1b, the first wireless communication apparatus may directly correct the measured noise by multiplying the second scaling factor by the noise measured in operation S110. Then, operation S130 may be performed.

Referring to FIG. 7B, subsequent to operation S110, in operation S121_2b, the first wireless communication apparatus may generate a third scaling factor based on the difference between the measured SNR and the measured EVM in operation S100.

In operation S122_2b, the first wireless communication apparatus may correct the measured noise by multiplying a reciprocal of a standard deviation of the noise measured in operation S110 by the third scaling factor. Then, operation S130 may be performed.

However, the present disclosure is not limited in this regard. For example, the first wireless communication apparatus may correct the measured noise by applying a scaling factor generated based on the difference between the measured SNR and the measured EVM to at least one of various values associated with noise.

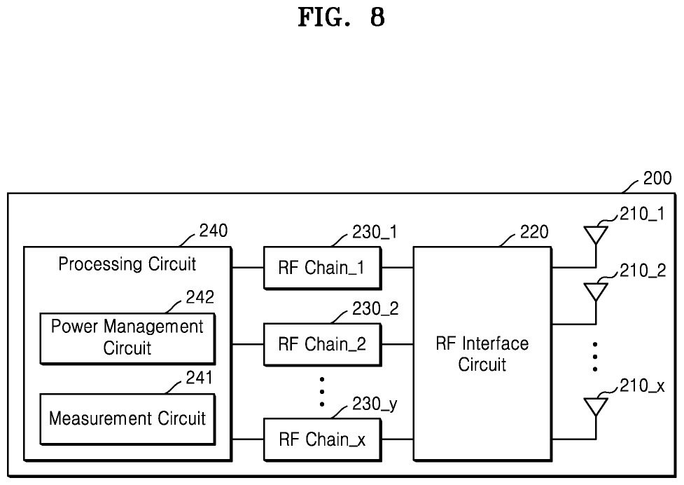

FIG. 8 is a block diagram illustrating a first wireless communication apparatus 200 according to an embodiment.

Referring to FIG. 8, the first wireless communication apparatus 200 may include a plurality of antennas 210_1 to 210_x (e.g., first antenna 210_1, second antenna 210_2, . . . , x-th antenna 210_x, hereinafter generally referred to as “210”, where x is an integer greater than zero (0)), an RF interface circuit 220, a plurality of RF chains 230_1 to 230_Y (e.g., first RF chain 230_1, second RF chain 230_2, . . . , y-th RF chain 230_y, hereinafter generally referred to as “230”, where y is an integer greater than zero (0)), and a processing circuit 240. In some embodiments, the RF interface circuit 220 and the plurality of RF chains 230 may be included in a transceiver.

The RF interface circuit 220 may form a plurality of reception paths by appropriately routing data signals received from the plurality of antennas 210 to the plurality of RF chains 230.

The plurality of RF chains 230 may transfer data signals provided by the RF interface circuit 220 to the processing circuit 240. In some embodiments, each RF chain of the plurality of RF chains 230 may include analog circuits such as, but not limited to, a low noise amplifier, a mixer, a filter, and the like.

In an embodiment, the processing circuit 240 may include a measurement circuit 241 and a power management circuit 242. The power management circuit 242 may control a power on mode and/or a power off mode of the plurality of antennas 210 and the plurality of RF chains 230 based on any one of a normal mode and a power saving mode. For example, the power management circuit 242 may activate (e.g., power on mode) the plurality of antennas 210 and the plurality of RF chains 230 in the normal mode, thereby forming reception paths for a plurality of data signals. Alternatively or additionally, in the power saving mode, the power management circuit 242 may activate one antenna of the plurality of antennas 210 and activate one RF chain of the plurality of RF chains 230, thereby forming a reception path for a data signal. As used herein, a reception path formed in the power saving mode may be referred to as a reference reception path. When a short training field (STF) of the preamble is detected in a data signal received through the reference reception path, the power management circuit 242 may switch from the power saving mode to the normal mode.

On the other hand, since a minimum period of time may be required for the inactive reception paths to transition to an activated state when switching from the power saving mode to the normal mode, noises for data signals received through the transitioning reception paths may not be properly measured before the transitioning reception paths are fully activated. As used herein, a transitioning period from the reception paths being switched from the power saving mode to the normal mode until the reception paths are fully activated may be referred to as an initial activation period.

Herein, a first data signal may refer to a data signal transmitted to the processing circuit 240 through the reference reception path during the initial activation period, and second data signals may refer to data signals that are transmitted to the processing circuit 240 through other reception paths during the initial activation period. Also, noise and EVM that are measured from the first data signal may be referred to as reference noise and reference EVM, respectively.

The measurement circuit 241, according to an embodiment, may correct noises measured from the second data signals based on the reference noise and the reference EVM measured from the first data signal.

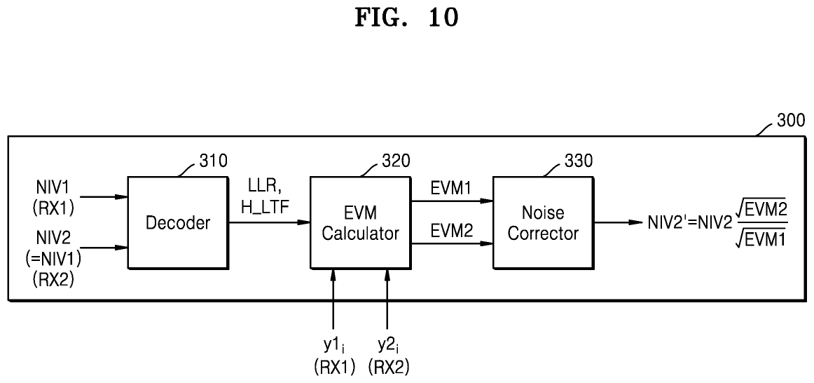

In an embodiment, the measurement circuit 241 may measure noises of the second data signals by replacing the noises of the second data signals with the reference noise measured from the first data signal. Then, the measurement circuit 241 may correct the measured noises of the second data signals based on EVMs measured from the second data signals and the reference EVM measured from the first data signal. An embodiment thereof is described with reference to FIG. 10.

The first wireless communication apparatus 200, according to an embodiment, may correct noises of data signals, which are received from reception paths other than the reference reception path that may not be accurately measured during the initial activation period, by using the measured noise and the measured EVM of the data signal received through the reference reception path. Thereby, potentially improving the measurement accuracy of the noises of the data signals received during the initial activation period.

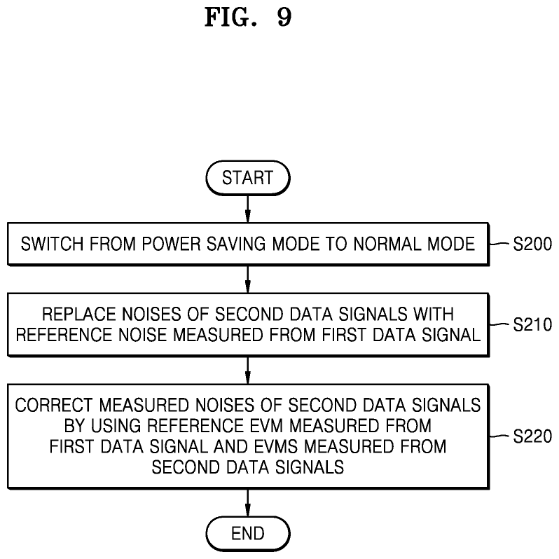

FIG. 9 is a flowchart of an operating method of a first wireless communication apparatus according to an embodiment.

Referring to FIG. 9, in operation S200, the first wireless communication apparatus may switch from the power saving mode to the normal mode. In an embodiment, the first wireless communication apparatus may form only a reference reception path in the power saving mode and may use the reference reception path for the purpose of detecting an STF in the preamble of the first data signal. For example, in the power saving mode, the first wireless communication apparatus may form a reference reception path by activating only an antenna (e.g., first antenna 210_1) and an RF chain (e.g., first RF chain 230_1) corresponding to the reference reception path. When switching from the power saving mode to the normal mode, the first wireless communication apparatus may receive the second data signals by additionally forming other reception paths in addition to the reference reception path. In detail, in the normal mode, the first wireless communication apparatus may additionally activate antennas (e.g., antennas 210_2 to 210_x) and RF chains (e.g., RF chains 230_2 to 230_y) corresponding to other reception paths to form other reception paths.

In operation S210, the first wireless communication apparatus may measure noises of the second data signals by replacing the noises of the second data signals with the reference noise measured from the first data signal.

In operation S220, the first wireless communication apparatus may correct the measured noises of the second data signals of operation S210 by using the reference EVM measured from the first data signal and the EVMs measured from the second data signals.

In some embodiments, the corrected noise of the second data signals may be realized by a reciprocal of a standard deviation of the noise measured from the first data signal.

FIG. 10 is a block diagram illustrating a measurement circuit 300, according to an embodiment. The measurement circuit 300 may include or may be similar to the measurement circuit 241 described above with reference to FIGS. 8 and 9, and may include additional features not mentioned above. In FIG. 10, only components necessary to describe an embodiment of the measurement circuit 241 described above with reference to FIGS. 8 and 9 are illustrated. That is, the number and arrangement of components of the measurement circuit 300 shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Alternatively or additionally, a set of (one or more) components shown in FIG. 10 may be integrated with each other, and/or may be implemented as an integrated circuit, as software, and/or a combination of circuits and software.

Referring to FIG. 10, the measurement circuit 300 may include a decoder 310, an EVM calculator 320 and a noise corrector 330. Hereinafter, it may be assumed that a first reception path RX1 is a reference reception path, and a second reception path RX2 is a path formed when switching from the power saving mode to the normal mode. Also, the first reception path RX1 may include a first antenna (e.g., first antenna 210_1) and a first RF chain (e.g., first RF chain 230_1), and the second reception path RX2 may include a second antenna (e.g., second antenna 210_2) and a second RF chain (e.g., second RF chain 230_2).

The decoder 310 may receive a first NIV NIV1 of the first data signal that may be transmitted through the first reception path RX1 during the initial activation period and a second NIV NIV2 of the second data signal that may be transmitted through the second reception path RX2. In an embodiment, the second NIV NIV2 may be replaced with the first NIV NIV1 to be the same as the first NIV NIV1. The first NIV NIV1 may be referred to as reference NIV. The decoder 310 may perform channel decoding by using the first and second NIVs NIV1 and NIV2 and generate LLR and channel values H_LTF and provide the values to the EVM calculator 320.

The EVM calculator 320 may further receive a first vector y1ᵢ corresponding to a symbol of an i-th sub-carrier of the first data signal received through the first reception path RX1 and a second vector y2ᵢ corresponding to a symbol of an i-th sub-carrier of the second data signal received through the second reception path RX2. The EVM calculator 320 may measure first EVM EVM1 and second EVM EVM2 with respect to the first data signal based on Equation 8 below.

$$\sum {\vert y {1}_{i} - {H}_{L \_ LTF} \hat{S} \vert}^{2} = EVM 1 \\ \sum {\vert y {2}_{i} - {H}_{L \_ LTF} \hat{S} \vert}^{2} = EVM 2 \qquad [ Equation 8 ]$$

In an embodiment, the EVM calculator 320 may measure the first EVM EVM1 by summing up calculation values, using the first vector y1ᵢ, a channel value H_{L_LTF}, and a reference vector Ŝ facing an ideal constellation corresponding to a corresponding symbol, for each of the symbols of sub-carriers of the first data signal. Also, the EVM calculator 320 may measure the second EVM EVM2 by summing up calculation values using the second vector y2ᵢ, the channel value H_{L_LTF}, and the reference vector S facing an ideal constellation corresponding to a corresponding symbol, for each of the symbols of sub-carriers of the first data signal. The first EVM EVM1 may also be referred to as a reference EVM.

In an embodiment, the noise corrector 330 may correct the second NIV NIV2 of the second data signal based on the first EVM EVM1 and the second EVM EVM2 provided from the EVM calculator 320. The noise corrector 330 may correct the second NIV NIV2 based on Equation 9 below.

$$NIV {2}^{′} = NIV 2 \frac{\sqrt{EVM 2}}{\sqrt{EVM 1}} \qquad [ Equation 9 ]$$

In an embodiment, the noise corrector 330 may multiply the second NIV NIV2, which may be identical to the first NIV NIV1, by a root value of a ratio between the first and second EVMs EVM1 and EVM2, and output the corrected second NIV NIV2′. The corrected second NIV NIV2′ may be used for processing the second data signal.

However, the present disclosure is not limited in this regard. For example, the measurement circuit 300 may correct the second EVM EVM2 by using the first NIV NIV1 and the first EVM EVM1 corresponding to the reference reception path in various ways.

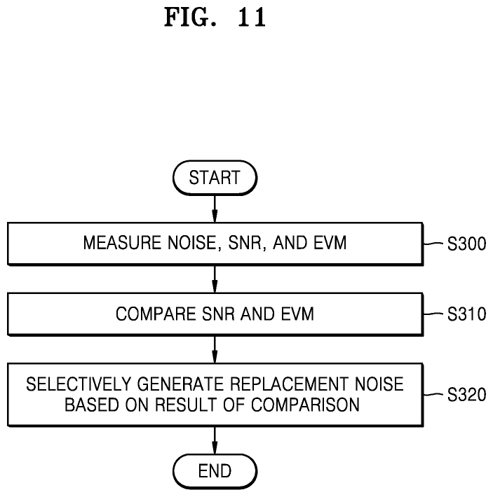

FIG. 11 is a flowchart of an operation of a first wireless communication apparatus, according to an embodiment.

Referring to FIG. 11, in operation S300, the first wireless communication apparatus may measure noise, an SNR, and EVM of a data signal received through a channel from a second wireless communication apparatus.

In operation S310, the first wireless communication apparatus may compare the measured SNR with the measured EVM. In an embodiment, the first wireless communication apparatus may detect impairment of the received data signal based on a difference between the measured SNR and the measured EVM.

In operation S320, the first wireless communication apparatus may selectively generate replacement noise based on the result of the comparison of operation S310. In an embodiment, the first wireless communication apparatus may generate, through the result of the comparison of operation S320, replacement noise when impairment of a received data signal has been detected. The first wireless communication apparatus may replace the noise measured in operation S300 with the replacement noise and perform an operation using the replacement noise.

As described above, the replacement noise may be realized by a reciprocal of a standard deviation of the noise.

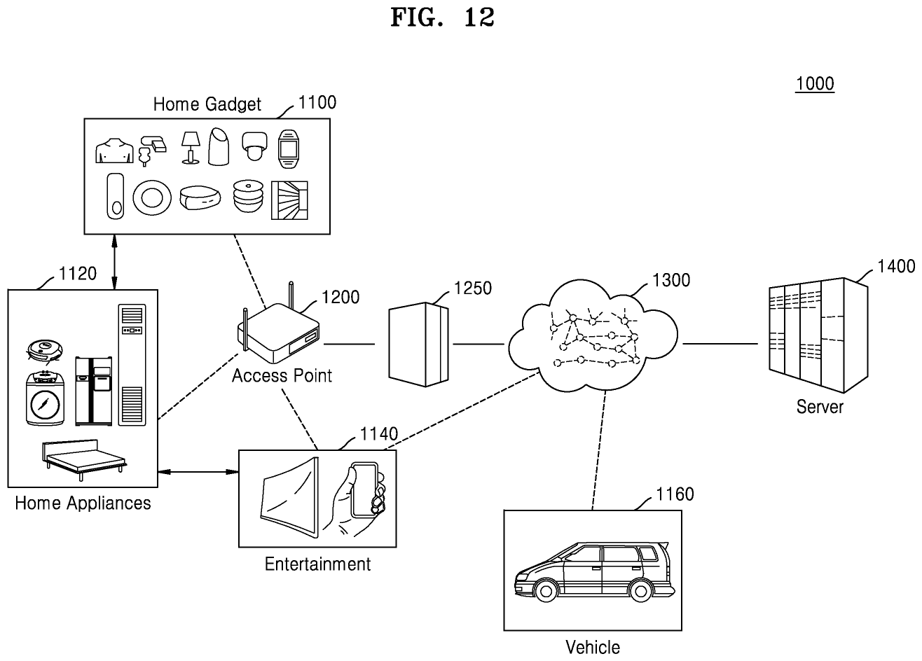

FIG. 12 is a conceptual diagram illustrating an Internet of Things (IoT) network system 1000 in which embodiments of the present disclosure may be applied.

Referring to FIG. 12, the IoT network system 1000 may include a plurality of IoT devices (e.g., home gadgets 1100, home appliances 1120, entertainment devices 1140, and vehicles 1160), an access point 1200, a gateway 1250, a wireless network 1300, and a server 1400. The IoT may refer to a network between objects that may use wired and/or wireless communication.

Each of the IoT devices 1100, 1120, 1140, and 1160 may form a group according to characteristics of each IoT device. For example, IoT devices may be grouped into a home gadget group 1100, a home appliance/furniture group 1120, an entertainment group 1140, or a vehicle group 1160. The plurality of IoT devices 1100, 1120, and 1140 may be connected to a communication network and/or to other IoT devices through the access point 1200. The access point 1200 may be embedded in an IoT device. The gateway 1250 may change a protocol to connect the access point 1200 to an external wireless network. The IoT devices 1100, 1120, and 1140 may be connected to an external communication network through the gateway 1250. The wireless network 1300 may include the Internet and/or a public network. The plurality of IoT devices 1100, 1120, 1140, and 1160 may be connected to the server 1400 providing a certain service through the wireless network 1300, and a user may use a service through at least one of the plurality of IoT devices 1100, 1120, 1140, and 1160.

According to embodiments, the plurality of IoT devices 1100, 1120, 1140, and 1160 may perform a correction operation on noises measured according to the embodiments described in FIGS. 1 to 11. Accordingly, the IoT devices 1100, 1120, 1140, and 1160 may perform efficient and effective communication to provide quality services to users.

While certain embodiments the present disclosure have been particularly shown and described, it will be understood by those of ordinary skill in the art that various changes in form and details may be made therein without departing from the spirit and scope of the present disclosure as defined by the following claims.

What is claimed is:

1. A first wireless communication apparatus comprising:
a transceiver configured to receive a data signal from a second wireless communication apparatus through a channel; and
a processing circuit configured to:
measure noise, a signal to noise ratio (SNR), and error vector magnitude (EVM) of the data signal,
compare the SNR with the EVM, and
selectively perform, based on a result of the comparison of the SNR with the EVM, a correction operation on the noise.

2. The first wireless communication apparatus of claim 1, wherein the processing circuit is further configured to, based on a difference between the SNR and the EVM exceeding a threshold value, perform the correction operation on the noise, based on the difference between the SNR and the EVM.

3. The first wireless communication apparatus of claim 2, wherein the processing circuit is further configured to:
multiply the difference between the SNR and the EVM by a first scaling factor, and
perform, based on a result of the multiplication, the correction operation on the noise by adjusting a Q factor determined by the noise.

4. The first wireless communication apparatus of claim 2, wherein the processing circuit is further configured to:
generate a second scaling factor, based on the difference between the SNR and the EVM, and
perform the correction operation on the noise by multiplying the noise by the second scaling factor.

5. The first wireless communication apparatus of claim 2, wherein the processing circuit is further configured to:
generate a third scaling factor, based on the difference between the SNR and the EVM, and
perform the correction operation on the noise by multiplying a reciprocal of a standard deviation of the noise by the third scaling factor.

6. The first wireless communication apparatus of claim 2, wherein the processing circuit is further configured to:
generate replacement noise based on the EVM, and
perform the correction operation on the noise by replacing the noise with the replacement noise.

7. The first wireless communication apparatus of claim 1, wherein a frame format of the data signal comprises:
a first legacy-long training field (L-LTF) comprising first data having a first pattern;
a second L-LTF comprising second data having the first pattern; and
a plurality of signal (SIG) fields, and
wherein the processing circuit is further configured to:
measure the noise and the SNR by using data in the first L-LTF and the second L-LTF, and
measure the EVM by using data in at least one SIG field of the plurality of SIG fields.

8. The first wireless communication apparatus of claim 1, wherein the processing circuit is further configured to perform a whitening operation on the data signal, based on a corrected noise resulting from the correction operation.

9. The first wireless communication apparatus of claim 1, wherein the processing circuit is further configured to, based on a difference between the SNR and the EVM being less than a threshold value, skip the correction operation on the noise.

10. A first wireless communication apparatus comprising:
a transceiver configured to receive a data signal from a second wireless communication apparatus through a channel; and
a processing circuit configured to:
measure noise, a signal to noise ratio (SNR), and error vector magnitude (EVM) of the data signal,
perform a correction operation on the noise when a difference between the SNR and the EVM exceeds a threshold value, and
process the data signal, based on a result of performing the correction operation.

11. The first wireless communication apparatus of claim 10, wherein the processing circuit is further configured to perform the correction operation on the noise by indirectly correcting the noise by using a first scaling factor generated based on the difference between the SNR and the EVM.

12. The first wireless communication apparatus of claim 11, wherein the processing circuit is further configured to indirectly correct the noise by correcting at least one processing factor determined from the noise, by using the first scaling factor.

13. The first wireless communication apparatus of claim 10, wherein the processing circuit is further configured to perform the correction operation on the noise by directly correcting the noise by using a second scaling factor generated based on the difference between the SNR and the EVM.

14. The first wireless communication apparatus of claim 13, wherein the processing circuit is further configured to directly correct the noise by multiplying a reciprocal of a standard deviation of the noise by the second scaling factor.

15. The first wireless communication apparatus of claim 10, wherein the processing circuit is further configured to perform the correction operation on the noise by generating replacement noise to replace the noise, based on the EVM.

16. The first wireless communication apparatus of claim 10, wherein the data signal comprises a physical layer protocol data unit (PPDU) of a wireless local area network (WLAN) system.

17. The first wireless communication apparatus of claim 10, wherein the processing circuit is further configured to perform at least one of a maximum ratio combining (MRC) operation and a whitening operation on the data signal, based on a result of the correction operation.

18. The first wireless communication apparatus of claim 10, wherein the threshold value comprises a preset system parameter value of a wireless communication system.

19. A first wireless communication apparatus comprising:
a transceiver comprising a first radio frequency (RF) chain that is inactivated in a power saving mode and a second RF chain that is activated in the power saving mode; and
a processing circuit configured to correct first noise of a first data signal transmitted through the first RF chain in an initial activation period when switching from the power saving mode to a normal mode, based on a first error vector magnitude (EVM) of the first data signal and a second EVM of a second data signal transmitted through the second RF chain.

20. The first wireless communication apparatus of claim 19, wherein the processing circuit is further configured to replace the first noise in the initial activation period with second noise of the second data signal.
